(19) United States
(12) Patent Application Publication
(10) Pub. No.: US 2011/0099210 A1
(43) Pub. Date: Apr. 28, 2011

(54) PERSONNEL REGISTRATION AND MANAGEMENT SYSTEM AND RELATED METHODS

(76) Inventors: John F. WOODSON, II, Oviedo, FL (US); Arthur C. Norris, Mims, FL (US)

(21) Appl. No.: 12/910,171

(22) Filed: Oct. 22, 2010

Related U.S. Application Data
(60) Provisional application No. 61/253,991, filed on Oct. 22, 2009.

(51) Int. Cl. G06F 17/30

(52) U.S. Cl. 707/804; 707/E17.044

(57) ABSTRACT

A participant assignment system is for assigning a plurality of participants to a plurality of different teams. The system may include a participant database configured to store participant data for each participant comprising participant age and at least one participant preference, and a processor coupled to the participant database. The processor may be configured to (a) assign a given participant to a given team based upon the age of the given participant and overall team ages for the plurality of different teams, (b) recursively assign other participants to the given team based upon participant preferences, and (c) repeat (a) and (b) until each of the plurality of participants is assigned to a respective team.

### CROSS-REFERENCE TO RELATED APPLICATIONS

This application is based upon prior filed provisional application Ser. No. 61/253,991 filed Oct. 22, 2009, the disclosure of which is incorporated herein by reference in its entirety.

### FIELD OF THE INVENTION

The present invention relates to the field of computer-based personnel systems, and, more particularly, to a system for registration and management of groups or leagues and related methods.

### BACKGROUND OF THE INVENTION

Sports leagues are an integral part of society, providing social, recreational, and health benefits for children and adults alike. Sports organizations run the gamut from small, relatively informal associations, to multi-national organizations that facilitate leagues in hundreds or even thousands of locations. Regardless of the size, it can be challenging for any organization to perform the numerous activities required to effectively operate sports leagues. Such activities may include player sign up (i.e., registration), payment processing, team assignments, game scheduling, equipment management/acquisition, and communicating information to players and coaches, for example.

Various approaches have been developed to assist with certain sports league management activities. One such approach is provided by eteamz.com. Eteamz is a team sports website publisher which allows members to create a team or league website. Online tools are provided for do-it-yourself website design, communication, and group management. Eteamz allows users to build or search for websites, collect player and team fees online, access online registration and payment tools, find fundraising services, participate on sport specific message boards, search and register for camps, tournaments, teams and other events, read sport tips, and view instructional videos.

Despite the existence of such systems, further features and functionality may be desirable for sports league registration and management in many applications.

### BRIEF DESCRIPTION OF THE DRAWINGS

FIG. 1 is schematic block diagram of a personnel registration and management system for use with sports leagues in accordance with an embodiment of the invention.

FIG. 2 is a flow diagram providing a general overview of registration and management steps performed by the system server of FIG. 1.

FIG. 3 is a flow diagram illustrating preference-based team assignment steps performed by the system server of FIG. 1.

FIG. 4 is a flow diagram illustrating further team assignment steps performed by the system server of FIG. 1.

FIG. 5 is an exemplary form generated by the system server of FIG. 1 for collecting sports organization administrator information.

FIG. 6 is an exemplary form generated by the system server of FIG. 1 for collecting sports organization information.

FIGS. 7A-7D are a series of exemplary forms generated by the system server of FIG. 1 for collecting sports organization league information.

FIGS. 8 and 9 are exemplary forms generated by the system server of FIG. 1 for collecting player information.

FIG. 10 is an exemplary form generated by the system server of FIG. 1 for collecting parent/guardian information.

FIG. 11 is an exemplary form generated by the system server of FIG. 1 for collecting optional player preference information for use in team assignment.

FIGS. 12 and 13 are exemplary screen prints of a sports league draft rank table generated by the system server of FIG. 1 showing skills assessment results and various options for changing the draft ranking.

FIG. 14 is a table of a league player pool including players to be assigned to teams by the system server in accordance with an exemplary embodiment of the invention.

FIGS. 15-17 are a series of tables illustrating team player assignments performed by the system server of FIG. 1 for the players set forth in FIG. 14.

FIG. 18 is an exemplary screen print of a team information page generated by the system server of FIG. 1 in accordance with an exemplary embodiment.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

Generally speaking, a participant assignment system is provided herein for assigning a plurality of participants to a plurality of different teams. The system may include a participant database configured to store participant data for each participant comprising participant age and at least one participant preference, and a processor coupled to the participant database. The processor may be configured to (a) assign a given participant to a given team based upon the age of the given participant and overall team ages for the plurality of different teams, (b) recursively assign other participants to the given team based upon participant preferences, and (c) repeat (a) and (b) until each of the plurality of participants is assigned to a respective team.

More particularly, the participant data may further comprise participant gender, and (a) may further comprise assigning the given participant to the given team also based upon the gender of the given participant and team gender ratios. By way of example, the at least one participant preference may comprise a preference to be assigned with another participant. Furthermore, each of the plurality of different teams may have a coach assigned thereto, and the at least one participant preference may comprise a preference to be assigned with a given team coach. Moreover, the processor may be further configured to limit a number of participant assignments based upon participant preferences for a given team coach. In accordance with another example, the at least one participant preference may comprise a team practice day preference.

In addition, the participant data may further comprise at least one participant exception, and (b) may further comprise recursively assigning other participants to the given team based upon overlapping participant preferences and the participant exceptions. For example, the at least one participant exception comprises a team coach exception. Moreover, the processor may be further configured to limit a number of participant exceptions for a given team coach. Also by way of example, the participant exception may comprise a team practice day exception.

A related participant assignment method may be for assigning a plurality of participants to a plurality of different teams. The method may include (a) storing participant data for each participant a in a participant database, the participant data comprising participant age and at least one participant preference, (b) assigning a given participant to a given team based upon the age of the given participant and overall team ages for the plurality of different teams, (c) recursively assigning other participants to the given team based upon participant preferences, and repeating (b) and (c) until each of the plurality of participants is assigned to a respective team.

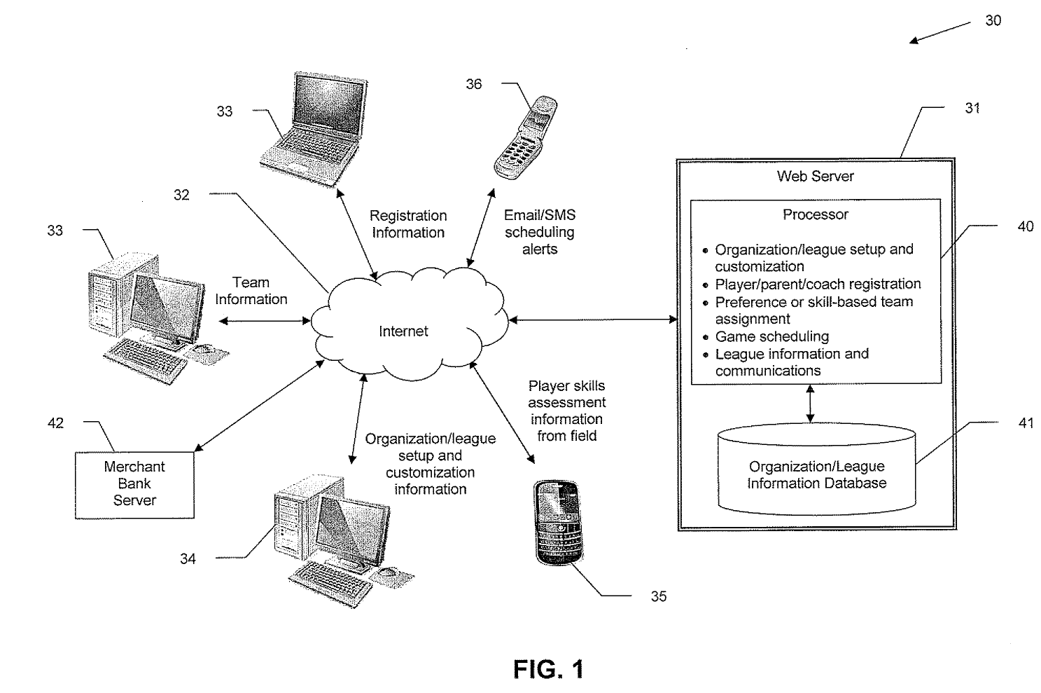

Referring initially to FIG. 1, the present invention is directed to a network (e.g., Web or Internet) based computer personnel management system 30, which will be described herein in the context of sports organization and league management applications, although it may be used for other personnel or participant management applications as well. The system 30 illustratively includes a server 31 which communicates with player/parent computer terminals 33 and sports organization administrator computer terminals 34 via the Internet/World Wide Web 32. By way of example, the computer terminals 33, 34 may be Macs, PCs, etc. Moreover, various Web-enabled mobile wireless communications devices 35 (e.g., smart phones, personal digital assistants (PDAs), etc.) and cellular phones 36 may also communicate with the server 31 via the Internet/Web 32 and respective wireless (e.g., cellular, wireless ZAN, etc.) communications networks etc., as will be appreciated by those skilled in the art.

The server 31 advantageously provides a centralized platform for managing numerous different sports organizations and their associated leagues. Generally speaking, the server 31 may provide the following functionality to registered users: organization/league registration and customization; league searches; player/parent registration; preference-based team assignments; game scheduling; and league communications. The server 31 may also interface with sports uniform and/or equipment provider systems to facilitate uniform/equipment purchases. These functional operations performed by the server 31 will be described in greater detail below.

In the exemplary embodiment, the server 31 illustratively includes a processor 40 which executes programming or scripting language commands to implement the above-noted functionality. The processor 40 may be implemented using a combination of hardware and software components. By way of example, the processor 40 may be implemented with a Web server application, such as Microsoft IIS, Apache, etc., as well as a Web-based scripting language application such as ASP, ASP.NET, PHP, ColdEusion, Ruby, etc., as will be appreciated by those skilled in the art. However, it will also be appreciated that the processor 40 may use other languages such as Java, C-based languages, etc., for the purposes of implementing the functionality described herein.

The Web server 31 further illustratively includes a database module 41 which cooperates with the processor 40 to store and retrieve the requisite organization, league, team, user, etc., information. By way of example, the database module 41 may be implemented with one or more database server programs such as Microsoft SQL Server, MySQL, Oracle servers, as well as other suitable database servers, as will be appreciated by those skilled in the art.

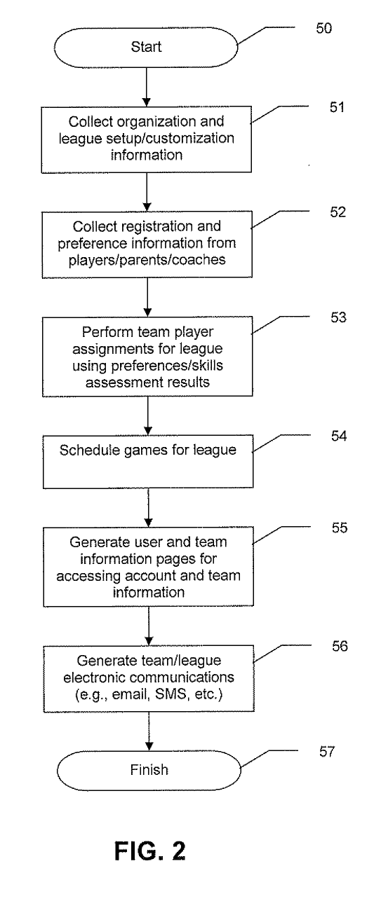

The various functional operations performed by the Web server 31 in the context of a sports organization management application will now initially be described with reference to FIG. 2. Beginning at Block 50, the server 31 initially interfaces with the administrator's input device 34 to collect information regarding his or her sports organization, the administrator, and sports leagues sponsored by the organization, at Block 51. More particularly, these devices interface with the server 31 via one or more Web pages at designated Web addresses or Uniform Resource Locator (URLs), as will be appreciated by those skilled in the art. In this regard, the various registration information may be collected by way of Web-based forms or form pages generated by the server 31 through which users interact with the server.

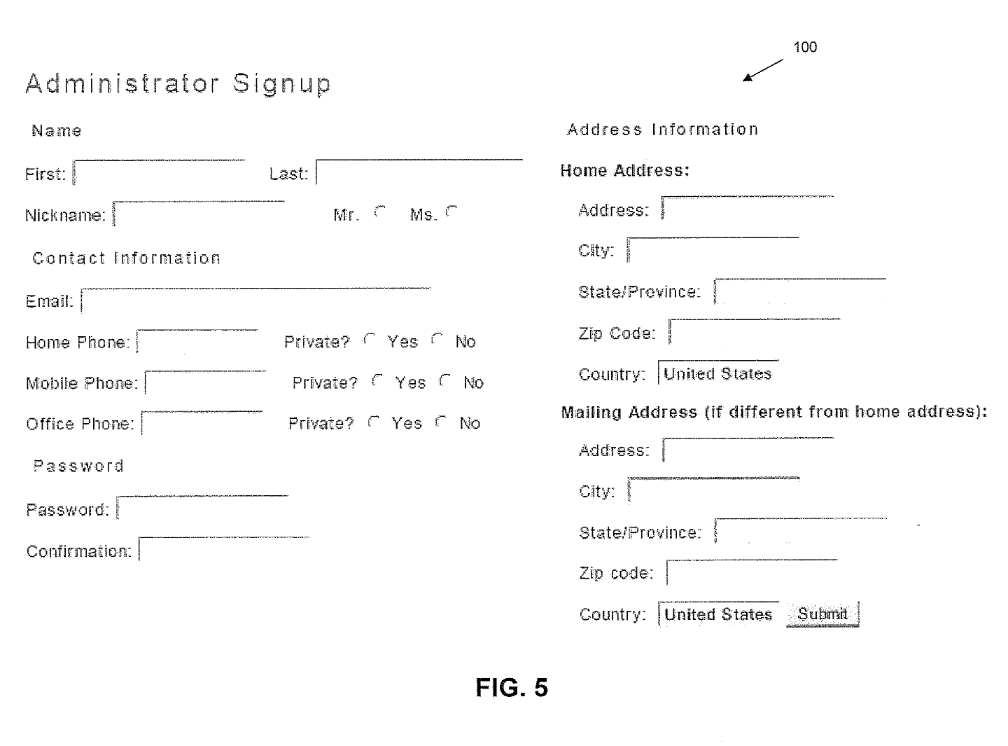

By way of example, an administrator signup form 100 is shown in FIG. 5. That is, the form 100 is for sports organization administrators to provide their respective name, contact, password, and address information to be stored in the database 41. More particularly, respective name fields are illustratively provided for the administrator's first and last names and nickname, name prefix (e.g., Mr./Ms.). The contact fields illustratively include email and home/phone/office phone numbers. Moreover, optional private designation fields may be included for one or more of the phone numbers (or email address). In this way, the processor 40 may advantageously allow users to be contacted through the system 30, yet without disclosing the phone number or email address to other users. For example, a user may wish to receive text message notifications of important league announcements (e.g., game cancellations, etc.) via SMS notification on his or her mobile phone, as illustratively shown with the cellular phone 36 (FIG. 1), yet not have the number accessible to other users, as will be discussed further below. The remaining form fields allow for entry of street address, city, state/providence, zip code, and country for both home and mailing addresses.

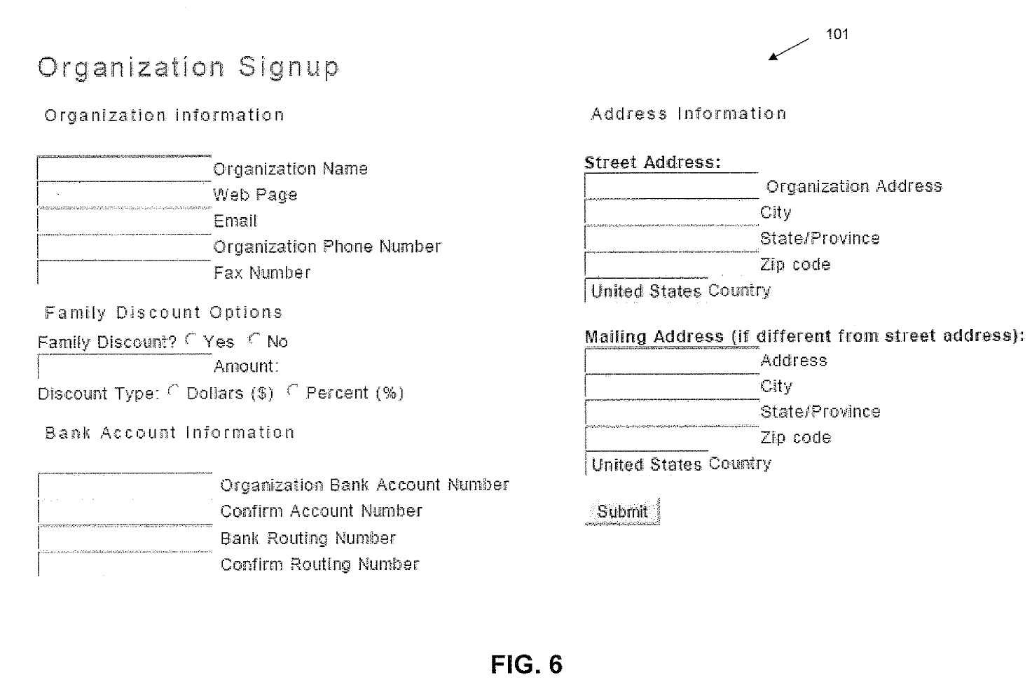

An exemplary organization signup form 101 is shown in FIG. 6. This form is for receiving information for the various organizations whose leagues are hosted by the server 31. More particularly, the form includes fields for general organization information, such as the organization name, Web site address, email contact address, and organization phone/fax numbers. Furthermore, family discount preference information, such as whether to provide a family discount, the quantity, and type (e.g., dollars or percent) of discount. That is, a discount may be applied when multiple family members sign up to play in leagues from the organization (e.g., full price for first player, $5 or 5% off for each additional player, etc.). The organization signup form 101 further illustratively includes form fields for entering (and confirming) organization bank account and routing numbers. This information may be stored in the database 41 so that registration fees collected via a merchant bank server 42 may be deposited to the sports organization's bank account, as will be appreciated by those skilled in the art, although such information need not be collected in all embodiments and payments may be made by other suitable approaches. The organization signup form 101 further illustratively includes P.O. box/street address, city, state/province, and zip code entry fields for receiving organization street and mailing address information.

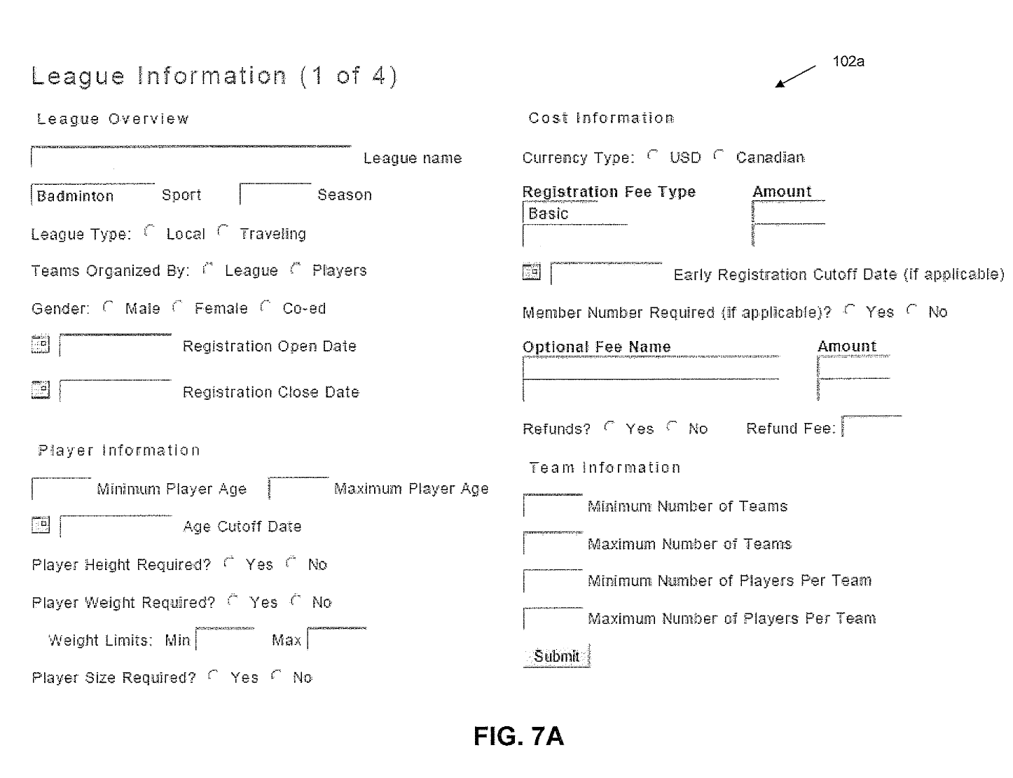

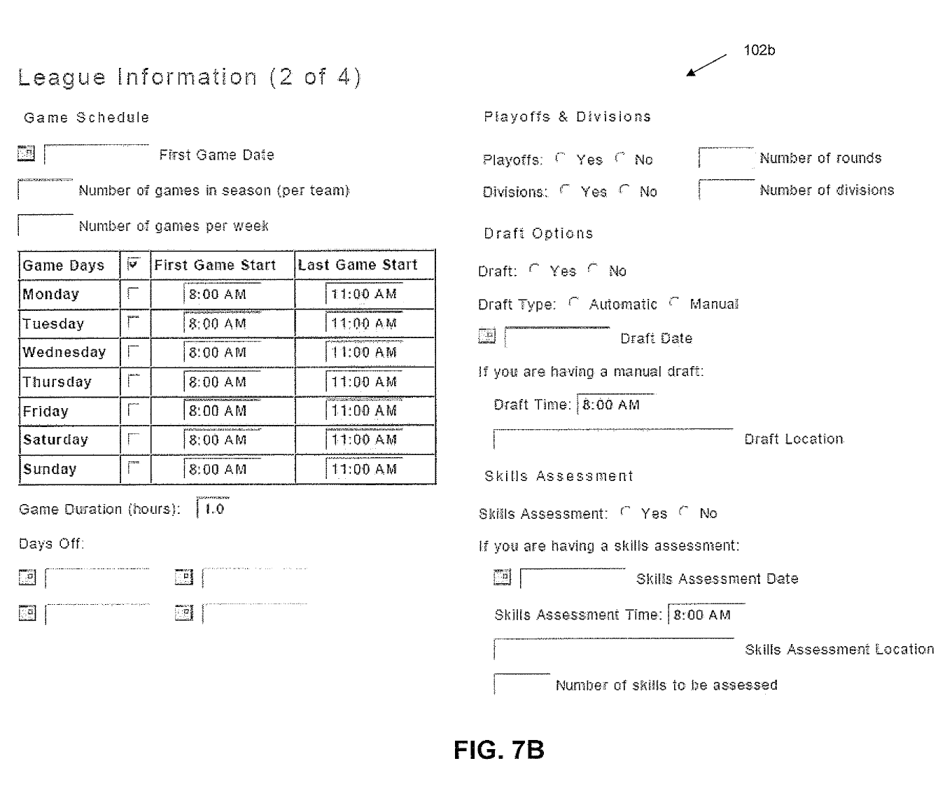

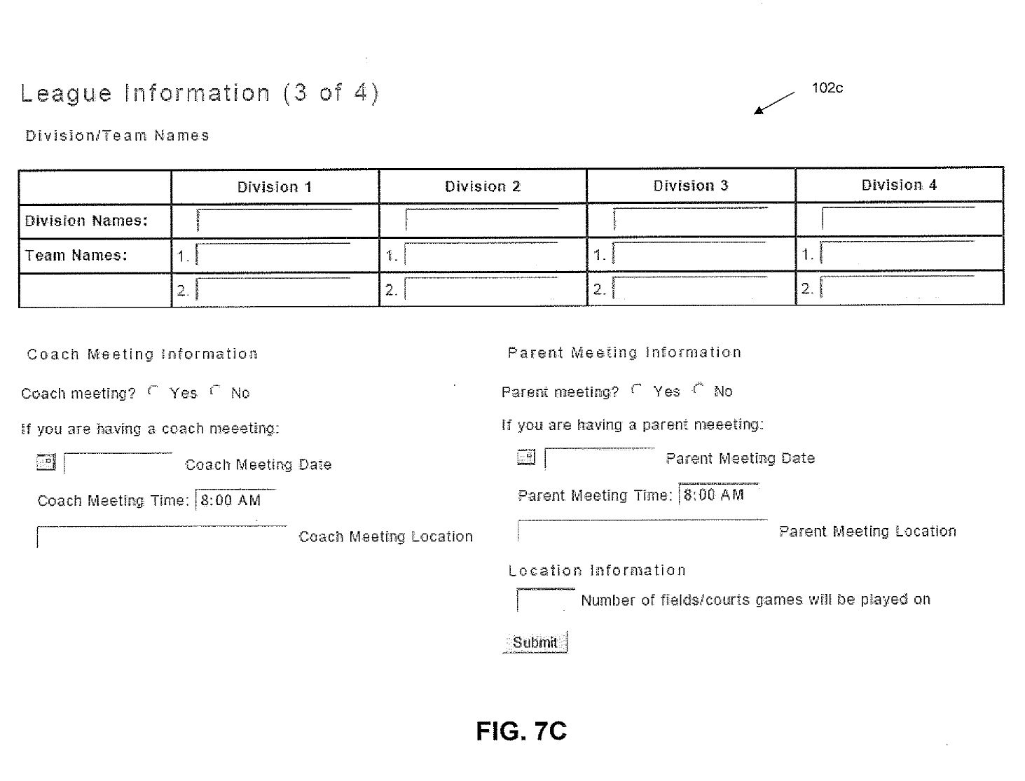

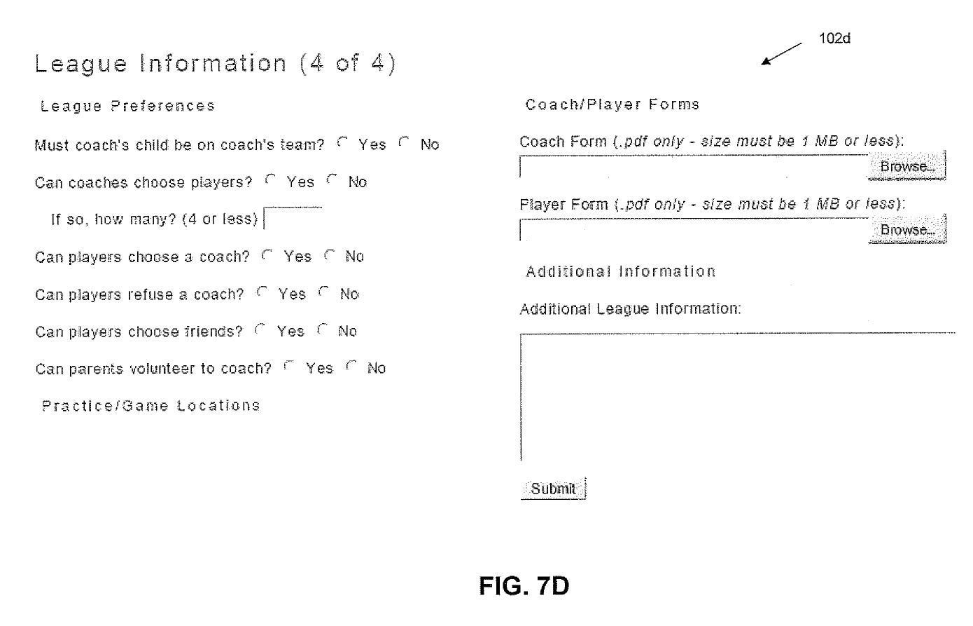

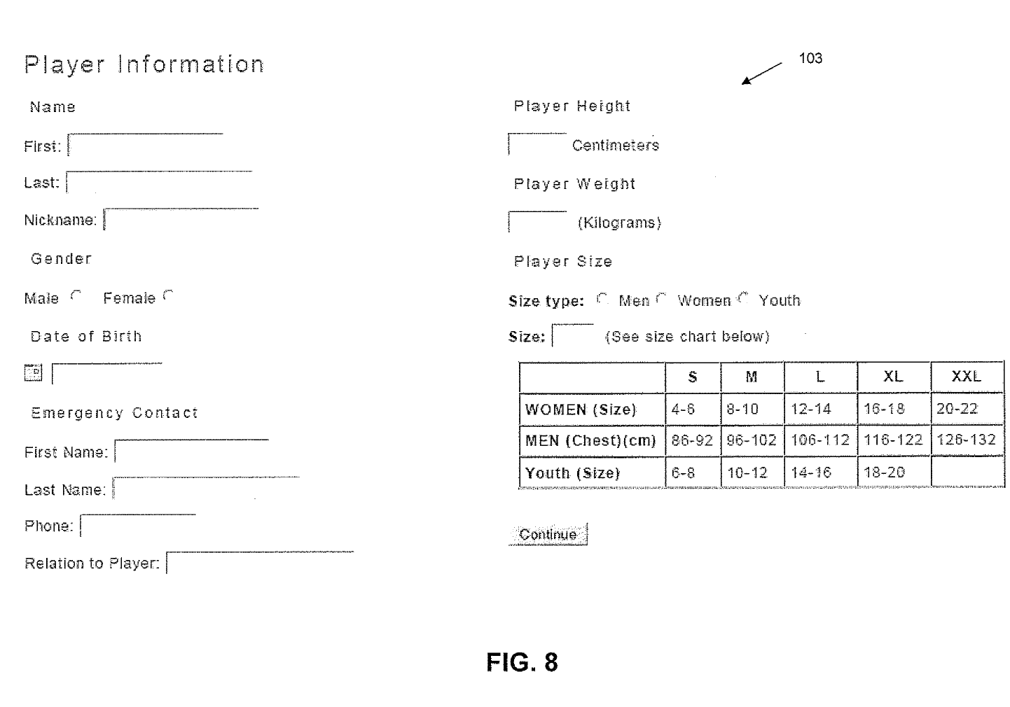

An exemplary league information form 102 is divided over four separate form pages 102a-102d and shown in FIGS. 7A-7D, respectively. The form page 102a illustratively includes the following league overview form fields: league name; sport type; season; league type; team organization type; gender; and registration open and close dates. More particularly, numerous types of sport leagues may be supported, such as: badminton; basketball; billiards; bowling; cross-country; fencing; field hockey; flag football; golf; ice hockey; racquetball; lacrosse; rowing; rugby; soccer; softball; street hockey; swimming; tackle football; tee ball; tennis; track; and volleyball, for example. League types may include local and traveling leagues. Local leagues would include those where multiple teams play at a same location. A traveling league would include those where teams travel to each other's locations for games (i.e., home and away games). Leagues may also be designated as co-ed or male/female only.

The form page 102a further illustratively includes a player information section including the following form fields: minimum/maximum player ages; age cutoff date; and player height/weight/size requirements, including minimum and maximum weight limits. These fields advantageously allow the league administrator to set restrictions on what players are allowed to sign up for a given league, whether by age, size, or both. A cost information section on the form page 102a allows the administrator to provide information on what the various fees and costs associated with the league are, and these fields include: currency type selection (e.g., U.S. or Canadian); registration fee type and amount; early registration cutoff date (if applicable); and whether a member number is required (for member-based leagues, such as YMCA leagues, etc.). The registration fee type options advantageously allow different fee structures to be used, such as a basic fee structure, an early/late registration fee structure, a member/non-member fee structure, or a resident/non-resident fee structure (such as for a city sports organization league, for example). Refunds allowed and refund fee form fields are also provided among the cost information form fields so that the league administrator may define whether refunds to players are permitted, and if some portion of the fee is non-refundable. The form page 102a further illustratively includes team information fields allowing the administrator to define the minimum/maximum number of teams in the league and the minimum/maximum number of players allowed per team.

The form page 102b illustratively includes the following game schedule form fields: first game day; number of games in the season; number of games per week; game days; game duration; and game days that will be off days. More particularly, the administrator may advantageously select multiple days during the week on which to schedule games for the league. If one of the selected days (e.g., Saturday) falls on a holiday (e.g., Christmas), the administrator may advantageously define this day as a day off, and the processor 40 would cooperate with the database 41 to generate a game schedule which skips this designated day off based upon the number of games per season and games per week selections made by the administrator. Playoff/division form fields are also included to select whether the league will have playoffs or divisions, along with the number of playoff rounds and number of divisions.

Other fields on the form page 102b illustratively include draft option form fields to designate whether a draft will take place, whether the draft will be automatic or manual, and draft date/time/location. More particularly, an automatic draft is one performed by the server 31 based upon the various options that the administrator, coaches, and/or players (or player parents) have provided during registration, as will be discussed further below. A manual draft is one in which the coaches and/or administrator select which players will be on which team, and these results are manually entered into the database by the administrator via a Web-based entry form (not shown), as will be appreciated by those skilled in the art.

In some embodiments the server 31 may advantageously provide an online and real-time “draft room” into which the coaches (and optionally league administrator) enter by providing their appropriate login and password information. The draft room allows players to be selected in turn by the coaches by interfacing with the server 31 via a computer, etc., connected to the Internet 32. For example, this may be done in a round-robin or serpentine order, as will be appreciated by those skilled in the art. For coaches that are unable to participate in the online draft, automated picks may be made for those coaches by the processor 40 based upon a default player rank order, or a customized rank order that the coach sets prior to the designated draft time. Again, this rank order may be set via an online form generated by the processor 40 which shows coaches the players in a league along with skills assessment results or other information, and appropriate form fields to allow the ranking of the players to be modified or changed, as will also be discussed further below.

In this regard, the option for the administrator to utilize skills assessment information in the league is also provided by the form page 102b. More particularly, a skills assessment is held in certain sports leagues, typically after the registration period closes, during which all of the players who signed up for the league participate in various skill drills to help the league administrator and/or coaches determine the respective skill levels of the players for draft/team assignment purposes. That is, this information helps the coaches or the automated draft system more evenly distribute the player talent pool so the league is more competitive. In the form 102b, the administrator is provided with form fields to select whether a skills assessment will be used in the given league, as well as the date, time, and location of the skills assessment. Moreover, a form field is also provided to inquire as to the number of skills that will be tested at the skills assessment. Additional forms fields may also be provided on this or a different form page to allow the administrator to also fill in names for the various skills to be tested (e.g., “twenty yard dash”, “catch three balls”, etc.).

The server 31 may provide numerous advantages to league administrators to facilitate skills assessments. For example, with the number and name of the skills and the player names stored in the database 41, the processor 40 may advantageously generate form pages, which may be filled in online, e.g., by the administrator with a laptop at the location of the skills assessment. This could be done while the administrator's computer is connected to the internet 32 (via wired or wireless connection), or in some embodiments the forms could be downloaded for offline completion (e.g., through a browser program, or via a separate standalone computer program application that may be downloaded to the administrator's computer). The measured skills assessment results may down uploaded to the database 41 “real time” or stored on the administrator's (or other) computer and uploaded at a later time.

Another advantageous approach is that users may be able to download a mobile application to their smart phone or wireless PDA. For example, the smart phone 35 may have an application installed thereon which lists the various skills and player names, and allows the times, etc., to be filled in for each player for each skill. Moreover, the application may include a stop watch function, so that the person measuring a timed skill drill may conveniently measure the time from the smart phone 35, and when the stop button is pressed the time from the stopwatch is automatically stored and/or uploaded for that player without the need for further action on the operator's part. A similar stop watch function may also be implemented on a Web-based form if the administrator is entering the information via his computer in the field, as will be appreciated by those skilled in the art.

Other convenience features may also be provided in a mobile device application, such as number buttons on a touch screen for a numbered skill (e.g., buttons labeled “1”, “2”, and “3” for a three catch skill drill so the operator simply pushes the number of successful catches to automatically store/upload the result for the selected player). Yet another example would be for a distance assessment, such as a long ball throw. For example, if one of the skills drills is to measure how far a player can throw a football, if the smart phone 35 is GPS enabled, then the application may prompt the operator to go to the starting line from which the ball is to be thrown to determine the GPS position thereof. Then, the operator selects the name of the next player to throw (e.g., from a pull-down menu), and walks to the location where the ball lands. The operator presses a button to indicate that he or she is standing at the geospatial position where the ball landed, and the device automatically calculates the distance of the throw and stores/uploads this value to the server 31. Alternatively, the smart phone application may cause the basic lat/long coordinates to be uploaded to the server 31, allowing the processor 40 to perform the distance determination, if desired.

The form page 102c illustratively includes form fields for entering division and respective team names. More particularly, the form page 102c may take the previously entered information regarding the number of divisions and maximum number of teams to create a grid or table for associating respective divisions and teams names, as shown. The form page 102c also illustratively includes a coach meeting information section with a yes/no field as well as meeting date/time/location fields, for leagues in which the league administrator is to require a coach meeting prior to the beginning of the season. Similarly, a parent meeting information section illustratively includes a yes/no radio button form field, as well as data/time/location fields. Another included field is for field/court information, namely to determine how many fields/courts games are to be played on for the league.

This information may then be used to generate practice/game location form fields on the form page 102d for the administrator to provide the names (and in some embodiments, locations) of the fields. However, in some embodiments the number of fields and names of fields need not be separated on different form pages. Moreover, in some embodiments a device-side scripting language, such as JavaScript, may be used to provide interactive form fields, such as “popping up” the appropriate number of game/practice location fields on the user's display based upon the number of locations that the administrator indicates in an initial field. Other form fields described herein may also be generated using a device-side scripting language, as opposed to a server side language, as will be readily appreciated by those skilled in the art.

The form page 102d also illustratively includes a plurality of league preference or consideration form fields. The first of these is to input whether coaches' children are required to be on their respective teams. That is, the administrator has the option to require that players be assigned to their parents' teams if their parents are coaching in the league. Another preference option is whether coaches get to select or chose particular players they way to be on their team, i.e., in leagues where there is no draft. For example, in leagues where there is no skills assessment and no draft (which is common in leagues with relatively young players), form fields are provided to input whether coaches are allowed to pick other children than their own, and if the administrator wants to place a cap or limit on the number of players that each coach can pick.

Still other particularly advantageous preference options are whether players are allowed to choose a preferred coach, or to refuse to be on a particular coach's team, for which respective radio button form fields are provided, as shown. However, it will be appreciated by those skilled in the art that other suitable form field types may be used for these or other form fields discussed herein. Further preference options include whether players may choose a friend(s) to be on the same team with, and whether parents are permitted to volunteer to coach unsolicited (as opposed to the administrator accepting coaches by invitation only). The league information form page 102d also illustratively includes file upload form fields to optionally upload a coach document and/or player document, which may be filled out, signed, and returned to the administrator. For example, the player document may be a permission document that players (or their parents/guardians) have to sign and return, and the coach document may require information from the coach to perform a background check, etc. Of course, such information may be collected via a coach information form (i.e., an online form) as well, if a signature, etc. is not required. An additional form field in the form page 102d is a text entry field allowing the administrator to enter additional league information that would be helpful for someone signing up for the league to know (e.g., players are required to bring birth certificates to the skills assessment, etc.).

Once the organization administrator has completed the league registration process, when the registration open date occurs then the server 31 will allow players (or parents for minor players) and coaches to begin registering for the league, at Block 52. The server 31 may further illustratively generate a first player form 103 for collecting requisite player information. More particularly, the form 103 illustratively includes form fields for player name (e.g., first, last, nickname), gender, and date of birth. Other exemplary form fields may include emergency contact information (e.g., first/last names, phone, relationship to player, etc.). Other player information collected via the form 103 may include player height, weight, size type (e.g., men/women/youth), and size (e.g., small, medium, large, XL, XXL). The server 31 selectively includes these fields on the form 103 based upon the information entered by the administrator when registering the league. That is, as noted above, the form 102a inquires of the administrator whether player height, weight, and/or size are required. If the administrator indicates that any of these are required, this information is stored in the database 41 so that when a player registers or signs up for this league the processor 40 will determine whether to generate such form entry fields, and require the player to enter this information to complete the registration process. Otherwise, the fields are not generated on the form 102a, as will be appreciated by those skilled in the art.

Depending upon the age of the player, the contact information required will either be that of the player (i.e., if the player is an adult or an older teenager permitted to have their own account) or the parent (i.e., for minor children). By way of example, this determination may be based upon the minimum and/or maximum ages designated for the league by the administrator, or it could be based off of the date of birth entered by the player, for example. In the event that the player is an adult (or otherwise permitted to provide his or her own contact information), then a second player information form 104 is generated upon submission of the first player information form 103. The form 104 includes home and optionally mailing address information, including street or P.O. box, city, state/providence, zip code, and country. Moreover, the form 104 also advantageously has an SMS delivery preference and carrier name so that the player can designate whether he or she wishes to receive no text (i.e., SMS) messages, all text messages, or only priority messages via text, as will be discussed further below. The option to receive text only, email only, or both text and email (e.g., all messages are delivered but priority messages are also (or instead) delivered by text) may also be provided.

If the player is a minor, then the minor is preferably not permitted to establish an account with the server 31 and instead of the form 104, after submission of the first player form 102 then a parent/guardian submission form 105 is instead provided for the player's parent or guardian to complete. Similar to the second player information form 104, the form 105 illustratively includes name information form fields (first, last, nickname, etc.). The form 105 further illustratively includes the following form fields: relationship to the player; date of birth; contact information including email, home/office/mobile phone; SMS (i.e., text message) delivery preference and carrier name; and whether the parent/guardian would like to volunteer to coach. Again, this last option would be provided on the form 105 only if the administrator had indicated on the form page 102d that parents/guardians are permitted to volunteer, as noted above. The form 105 also illustratively includes forms for the parent/guardian to enter home and mailing address information (i.e., street/P.O. box, city, state/province, zip code, and country, and well as password and password confirmation fields.

Once the form 104 or 105 is completed and submitted, as appropriate, then the player or parent/guardian is directed to a form 106 to designate his or her preferences. Here again, these optional preferences are made available or not based upon the choices made by the administrator when completing the form page 102d, as discussed further above. For example, if the administrator allows a friend preference, then the player or parent/guardian will be asked for the name of a friend that the player would like to be on the same team with. More particularly, in the illustrated example a pull-down list may be provided with all of the names of other players who previously signed up for the league for the player or parent/guardian to search. If the friend has not yet signed up for the league, name fields (i.e., friends' first name, friend's last name, friend's nickname) are provided for the player or parent/guardian to complete. This information may then be stored in the database 41 and compared at a later time to the list of players who have signed up for the league (i.e., to find the player's friend on the player roster if the friend signs up at a later time) by the processor 40.

In this regard, a player or parent/guardian may not want the player's name to be visible in the friend pull-down list for security or other reasons. As such, a form field (e.g., a yes/no radio button form field) may be provided to allow the player or parent/guardian to designate whether the player's name should be available to other's in this pull-down field when other players sign up. Similar form fields to the friend preference fields are also provided for the coach preference (i.e., selecting a coach whose team the player WANTS to be on) and no coach preference (i.e., selecting a coach whose team the player DOES NOT want to be on), as shown. The optional preference form 106 may further include preference form fields for preferences such as preferred practice days and non-preferred practice days (which may be further broken down into days when practice is possible but not preferred or when practice is not at all possible for the player on that day).

Although not shown, one or more additional forms similar to those described above for the players and parent/guardian may also be provided for receiving coach information, including name, contact information, home/mailing address, password/confirmation, SMS notification preference, date of birth, etc. Other information may also be collected, such as years of experience coaching the sport, whether the coach wants to he a head or an assistant coach, whether the coach wants to partner with another coach (and the name of the other coach if there is a specific one), etc. Coaches may also be permitted to enter preference information, such as other players they want on their team, they prefer (or not) to have practices, etc.

The server 31 may advantageously only allow a coach to sign up for a league with minor players if the person is also signed up as a parent for a player, or optionally upon invitation (e.g., an email invitation generated upon request by the server) from a registered parent or the league administrator, so that coaching in the league is not generally open to the public simply by logging on to a Web page for the league hosted by the server. Thus, for example, if a mother signed her minor son up for a league, the mother could select an option indicating that the child's father wants to volunteer to coach, and provides the father's email address. The father would then receive an email from the server inviting the father to sign up to coach the child's team (or simply to sign up as a second authorized parent who can access the child's team information), and the father would be added as a system user and a coach for the team. In some embodiments, the administrator may still have the option to confirm coaches before they are finalized, if desired, by the server 31.

Once the league registration close date has passed, various approaches may be used for assigning players to the various teams, at Block 53. Generally speaking, there are two types of team assignment approaches that are performed by the server 31, namely (1) a draft or (2) a team fill based upon preferences and/or other considerations. More particularly, a draft may take one of two forms, the first being a manual draft in which the coaches manually select players in person or online, and the second being an automatic draft. With a manual or in person draft, the administrator may later manually add the names of players into the database 41 via a Web interface form, as will be appreciated by those skilled in the art. With an online draft, the coaches may choose the players to be on their team via an online draft room or chat room generated by the processor 40, which also stores the draft selection choices in the database 41, as will be appreciated by those skilled in the art.

Many leagues that implement a draft will also have a skills assessment which provides the coaches with an approximation of the skill levels of the players so that the coaches can make their informed selections, as will be understood by those skilled in the art. In the case of a manual draft, the results of the skills assessment may be ordered in table form for the coaches to view or print for reference. Coaches may also be provided with the option to re-order or change the default ranking of the players, as will now be discussed.

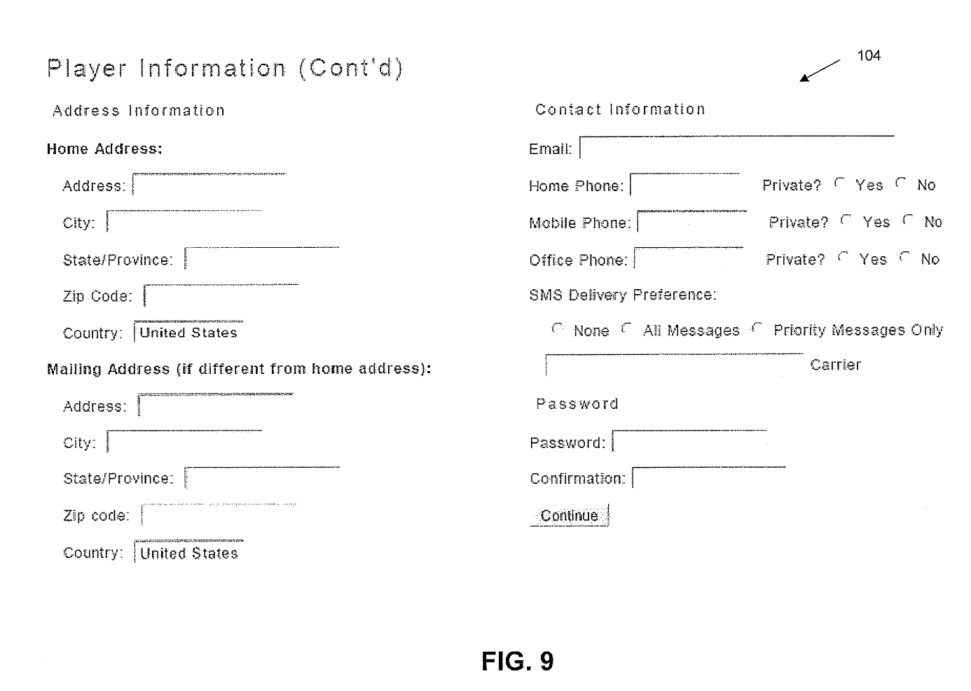

An exemplary player skills assessment result table 120 is shown in FIG. 12. Here, the default ranking is created by the processor 40 based upon the skills assessment result values stored in the database 41 for the particular league, and more particularly based upon an average of the different skill results (three in the illustrated example). So, in the table 120, the three skill results (30 yard dash, three catches, and long throw) are equally weighted in determining a respective average for each player, and ultimately the player's ranking with respect to the other players.

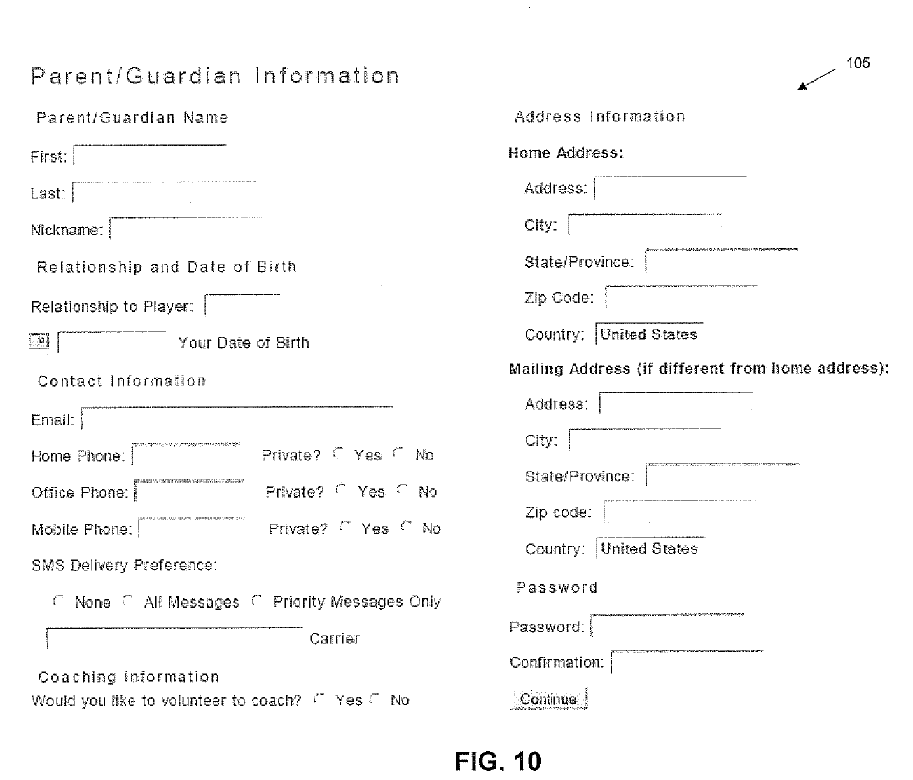

However, in some embodiments the default ranking may changed to use a different weighted average of the various skills. This weighted average could be set by the league administrator before hand, or as shown in the examples of FIGS. 12 and 13, percentage form fields 121 may be provided for each column, for example, to allow coaches to type in a new ratio of weighting percentages so the players are re-ranked accordingly. In the illustrated example, the coach wants the rankings most heavily weighted toward speed and least heavily toward the number of catches, and so the coach assigns a 55% weight to the 30 yard dash skills assessment, a 20% weight to the three catches skills assessment, and a 25% weight to the long throw skills assessment. This weighting would change the results from those shown in FIG. 12 to those shown in FIG. 13, namely it changes the order of Tom Tyler from #1 to #2, and Jason Jones from #2 to #1, as shown. This advantageously allows the coach to customize the formulation by which players are ranked for his draft order, and therefore the order in which these players will be drafted to his team in an automatic draft performed by the processor 40, as will be appreciated by those skilled in the art.

Similarly, a form field 122 is also provided adjacent each row for a coach to type in a new rank order number for individual players, which thereby changes the player's rank in the coach's draft order. The player's rank order may also be changed in increments of one (or more) by the up/down arrow keys 123, 124 at the end of each row. The customized coach rank orders are stored in the database 41. Once the coaches have placed the players in their preferred rank order and the administrator initiates the automated draft, the processor 40 advantageously uses the customized rank orders to assign players to the coaches' teams accordingly, until the teams are all filled.

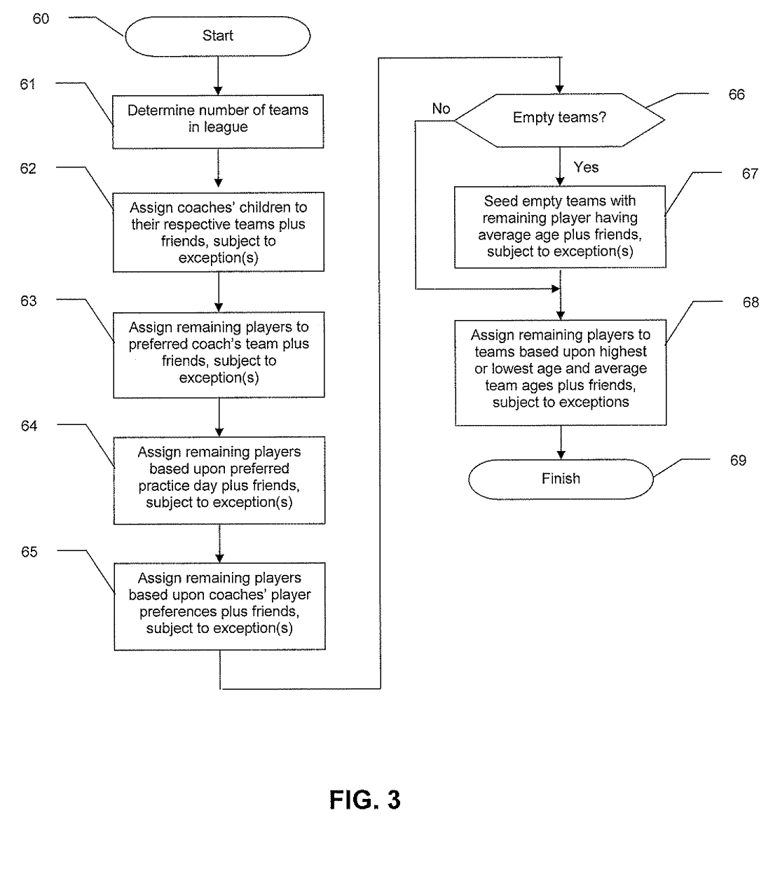

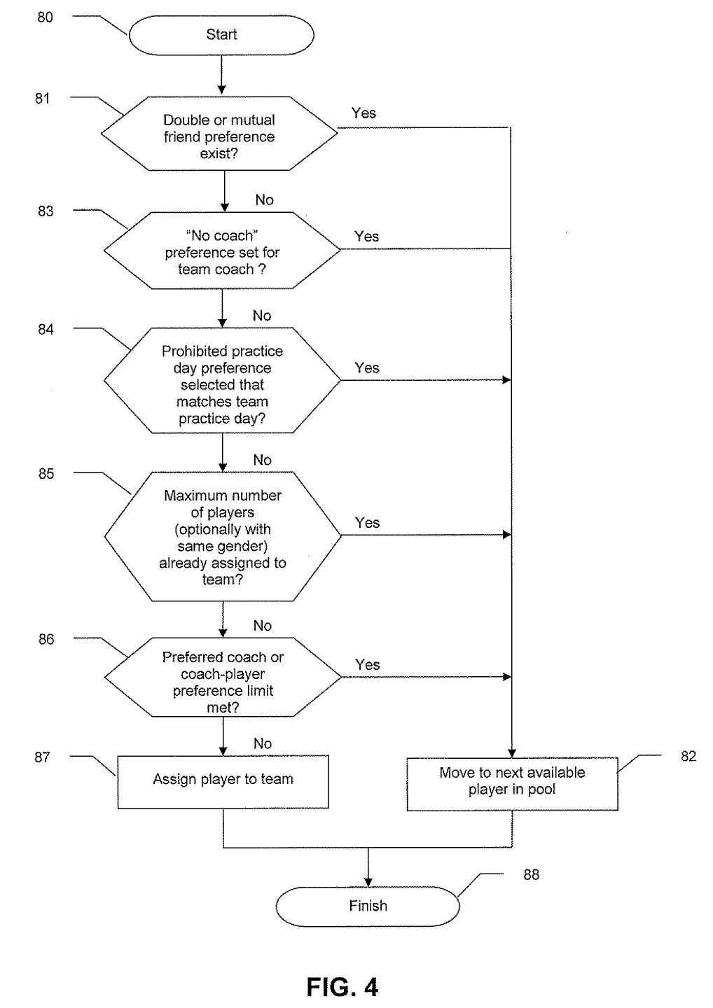

Turning now to FIGS. 3 and 4 and the automated team fill performed by the server 31, e.g., in leagues that do not have a draft, beginning at Block 60 a first operation to be performed is to determine how many teams there will be in the league, at Block 61. As discussed above with reference to form page 102a, the administrator is given the option to select a minimum and maximum number of teams for the league, as well as a minimum and maximum number of players per team. Depending upon the ranges provided by the administrator, there may potentially be multiple acceptable numbers of teams in the leagues, and the processor 40 will need to determine the appropriate number of teams to use before performing the player assignments.

The processor 40 utilizes various criteria for making such a selection. For example, the processor 40 may select an even number of teams when possible, which is helpful for game scheduling, although it is not required. The processor 40 may also select the maximum number of teams that meets the minimum player per team requirement. That is, since less players per team will generally maximize the playing time that players receive (i.e., because less players are on the team to vie for playing time), the processor 40 will attempt to create the most teams with the least amount of players possible. Moreover, the processor 40 may also account for the number of coaches (in particular, head coaches) that have signed up to coach in the league, and whether there are enough coaches to support a higher number of teams, or whether this requires a lesser number of teams. In some embodiments, if the various minimum/maximum teams/player numbers cannot be met, the server 31 may notify the administrator accordingly (e.g., via email or a user Web page generated for the administrator when he logs onto the server) so that he may change the team/player settings as appropriate.

Once the teams are established with their respective coaches, the players may then be assigned based upon the various preferences the players and/or the coaches have made, as well as other considerations. If the administrator has indicated that players are to be assigned to their parents' teams (i.e., where the parents are coaches), then the coaches' children may be assigned to their respective teams as a first step in the team assignment process, at Block 62. Moreover, if any of the coaches' children have selected a friend to be on their team (if allowed in the league), or another player has selected a coach's child as a friend, these friends are also added to the teams, subject to one or more exceptions, as will be discussed further below. This friend assignment may be a recursive operation, meaning that each time a new player is added to a team, the remaining player pool is checked for a player that was either designated as a friend by the newly added player or vice-versa, until the friend associations run their course.

A first potential exception that would exclude a player from otherwise being assigned to a team is whether a double or mutual friend preference exists, at Block 81. For example, if Player A is assigned to a team because he is the coach's son, and Player A has designated Player B as a friend, but Player B and Player C designated each other as friends (i.e., mutual or double friends), then the processor 40 will not assign Player B to Player A's team if Player C cannot also be assigned to that team. In other words, the processor 40 will ensure that Players B and C are assigned to the same team, and if it is not otherwise possible to assign them both to Player A's team, then Player A's friend preference will be ignored, i.e., the processor will move on to the next step and the next player in the pool to be assigned, at Block 82, and illustratively concluding the steps shown in FIG. 4 at that point (Block 88).

Once all of the coaches' children and their friends have been assigned to teams (subject to the double friend exception), a next step may be to assign players from the remaining or unassigned player pool based upon their preferred coach, again along with designated friends and subject to exceptions, at Block 63. Returning again to the exceptions of FIG. 4, one reason that a player may not be able to be assigned to a team is that the player has designated the team's coach as undesirable, i.e., the player has selected a “no coach” preference for this coach and does not want to be on that coach's team, at Block 83. So, for example, if Player A was assigned to a team and had selected Player B as a friend, if Player B had designated the no coach preference for the coach of Player A's team, Player A's friend preference would be ignored, since it is superseded by Player B's no coach preference.

Another preference that may be used to assign players to teams is the preferred practice day designated by the players, once again along with designated friends and potentially subject to exceptions, at Block 64. That is, if the administrator permits players (or parents) to designate a preferred day(s) for practice, then this criteria may be used at this point (or elsewhere in the team assignment process) to match the player with a team that has the preferred day(s) scheduled as a practice day (which selection is made by the coach, as noted above). As such, the player may designate the day(s) they prefer to practice on when registering for the league, and the processor 40 will attempt to assign the players to teams that have their practices scheduled on the same day, if possible.

A counterpart exception to this preference that may prohibit assignment of a player to a team is if a prohibited practice day preference has been set by the player (or parent), at Block 84. In other words, if Player B has designated that he or she cannot come to practice on a particular day of the week, and the team in question is scheduled to practice on that day, then Player B will not be assigned to that team. This may be considered a “hard” preference if the player indicates that he or she does not want to be assigned to a team that practices on this day under any circumstances (i.e., the player knows they cannot make practice on this day). However, this exception could also be set up as a “soft” preference, meaning that the processor 40 would allow an assignment to a team practicing on the day in question under some circumstances (e.g., a friend preference would trump or supersede the soft prohibited practice day preference). Both of the preferred practice day and prohibited practice day preferences may be used in a same implementation, or just one or the other (or neither). Of course, form field validation techniques may be used to prevent a user from making inconsistent or inappropriate data entries, such as selecting a same day of the week as a preferred and not preferred practice day, for example, as will be appreciated by those skilled in the art.

Another exception that may prevent a player from being assigned to a team is that a maximum number of players has already been assigned to the team, at Block 85. That is, the team may already be filled to the maximum number of allowed players designated by the administrator, as noted above. Another option is that teams may be balanced based upon gender in a co-ed league, for example, so that each team's male/female ratio reflects or is as close as possible to (i.e., within a threshold range of) that of the overall percentage of males and females in the league. Thus, once an allotted percentage of boys or girls is reached for the team, then no more players of the same sex would be added to the team, as will be discussed further below.

Still another optional exception that is a counterpart to the preferred coach preference is whether a preferred coach preference limit has been reached for the team, at Block 86. That is, the administrator may be given the option to limit how many players who request a given coach may be assigned to that coach's team. For example, if a coach is very popular, more than the maximum number of players for the team may request the coach. The administrator may desire to put a cap on the number of players who can be assigned to the team based upon this preference, such as to allow processor 40 to perform its other team balancing operations (e.g., balancing teams by gender, age, etc.) and thereby help make the teams more equal, if desired.

It will be appreciated that not all of the above-noted exceptions, which may conceptually be considered as “negative” preferences/considerations, need be applied after each “positive” preference/consideration shown in FIG. 3. That is, the preferred coach preference limit only needs to be run when attempting to assign a player to a team based upon the player's coach preference. Similarly, the “no coach” preference need not be run when assigning a player to his or her parent's team, since in most implementations a player will likely not be allowed to designate that he or she does not want to be on his parent's team (although this option is possible in some embodiments). Moreover, it should be noted that all of the steps illustrated in FIGS. 3 and 4 need not be used in all embodiments. That is, these preferences may be selectively chosen by the administrator when setting up the league, as described above with reference to FIGS. 7A through 7D, and therefore may be present in some implementations and not others, as will be appreciated by those skilled in the art.

Returning again to FIG. 3, after the preferred practice day preferences have been exhausted (i.e., the processor 40 has completed all possible assignments for players who designated a preferred practice day), unassigned players may then be assigned based upon the coaches' player preference, again along with designated friends and potentially subject to exceptions, at Block 64. That is, a coach may designate one or more players (beside his own child(ren)) that he wants to be on his team. As with the preferred coach preference, a limit may be placed on the amount of such players a given coach may designate to be on his team by the administrator, which would function as an exception to assigning a particular player to the coach's team if his quota had already been met (Block 86). Such a limit could also be placed on other preferences, such as the “no coach” preference (i.e., only a certain number of children are allowed to reject a coach before children will start being assigned to the coach's team). However, in this particular case, such a threshold may instead be used as a basis to provide a warning notification to the administrator that there is a problem with a particular coach, and that a replacement coach may be appropriate.

Once the preference-based assignments have been performed (Blocks 62-65), in many circumstances there will still be players remaining in the available player pool to be assigned to teams. The processor 40 may advantageously perform the remaining player assignments using balancing techniques to help equalize the ability levels of the teams in the league, and thereby promote fairness and/or more competitive teams. For example, these balancing techniques may include balancing player ages (i.e., the average age of players on a team) and, in the case of co-ed leagues, optionally balancing the ratio of males to females on the teams, to the best extent possible. As used herein, “balancing” is not intended to mean that the overall ages, gender ratios, etc., for the teams are required to be exactly the same or equal to one another, but rather that the processor 40 attempts to make them closer to one another than would otherwise occur from a random assignment, for example, and thereby help promote fairness across the teams.

As an initial consideration, it is possible that some teams in a league will not have any players assigned thereto (i.e., will be empty) after the above-described preference-based steps are completed, at Block 66, such as if there is a coach without a child in the league. In such case, to perform age balancing it may be desirable to seed the team with a player(s) of a desired age to help the age balancing of the various teams to converge more quickly, at Block 67. For example, an average (or median) age for all of the players remaining in the available player pool may be determined, and the player who is closest to this average age would then be assigned to the empty team. In some embodiments, the average player age could be based upon the entire player pool (i.e., all players in the league whether already assigned to a team or not). Thus, the average age for this given team will go from the lowest average (i.e., zero since no players were assigned to it) to the average age of the league or remaining player pool. The seeding would be performed for each empty team until all of the teams had at least one player.

At this point, age balancing may be performed, at Block 68, to assign the remaining players to teams based upon a highest or lowest player age from the pool of unassigned players, along with the recursive friend preference and subject to the above-described exceptions. More particularly, the average player age for all of the teams is calculated. The team with the lowest average age may then have the oldest player (i.e., highest age) from the unassigned player pool assigned to it. This will help to quickly bring the average team age up to those of the other teams, as will be appreciated by those skilled in the art. Conversely, the team with the highest average age may be assigned the youngest player (i.e., lowest age) to bring down the team's average age closer to that of the remaining teams.

In some implementations it may be helpful to use a combination of both oldest player to lowest average team, and youngest player to highest average team, such as by alternating from one to the other with each new player assigned. For example, the processor 40 may add the oldest remaining player to youngest average team until a point at which the oldest unassigned player is below the youngest team average (or vice-versa), at which point the processor 40 would begin assigning the youngest player to the oldest average age team. This age assignment process would continue until all of the players in the league have been assigned and the teams filled. Moreover, age balancing is not limited to player assignment based upon who is oldest (or youngest). For example, in some implementations it may be desirable to assign players by average (or median) age, as will be appreciated by those skilled in the art. For example, if assigning for a co-ed league, one sex could be assigned by average/median age, and the other sex by oldest/youngest, if desired.

Age balancing the teams advantageously helps to ensure the teams will be more fair and competitive, since older players (in the context of youth leagues) will typically be more skilled, stronger, coordinated, etc., athletes than the younger players. The converse may generally be said of adult leagues (e.g., an adult softball league), where older players (e.g., in their forties or fifties) may no longer have the physical abilities of players in their early twenties. So, by attempting to evenly distribute younger and older players across the teams, this mitigates against the possibility of one team accumulating all of the older (and statistically better) players in the case of youth leagues.

Generally speaking, the effectiveness of the age balancing will vary based upon the number and extent of preferences allowed by the administrator, and how many players actually designate preferences when registering. This advantageously allows the league administrator flexibility in determining how accommodating he wants to be with preferences versus how important it is to have the teams well balanced and competitive. For instance, in a very young league (e.g., 3-4 year old soccer league) where children are first learning to play the game and scores are not kept, team competitiveness is much less important than making sure the children are assigned to a team with a friend, for example. However, in a more-competitive upper age leagues (e.g., middle or high school age children), the administrator may desire to make the league more competitive (i.e., age balanced), and therefore allow less preference or exception options. Even so, age balancing as described above need not be used in all implementations for filling out the remaining team spots. Rather, this could simply be done in the order in which players signed up for the league, alphabetical order, from youngest to oldest (or vice-versa), etc.

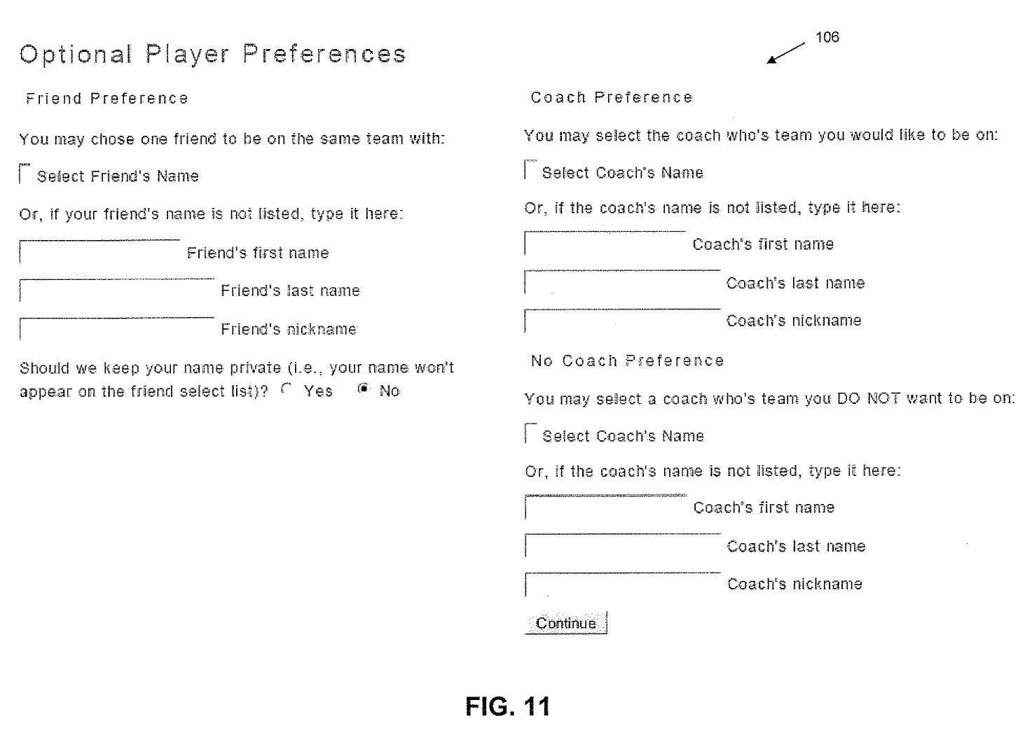

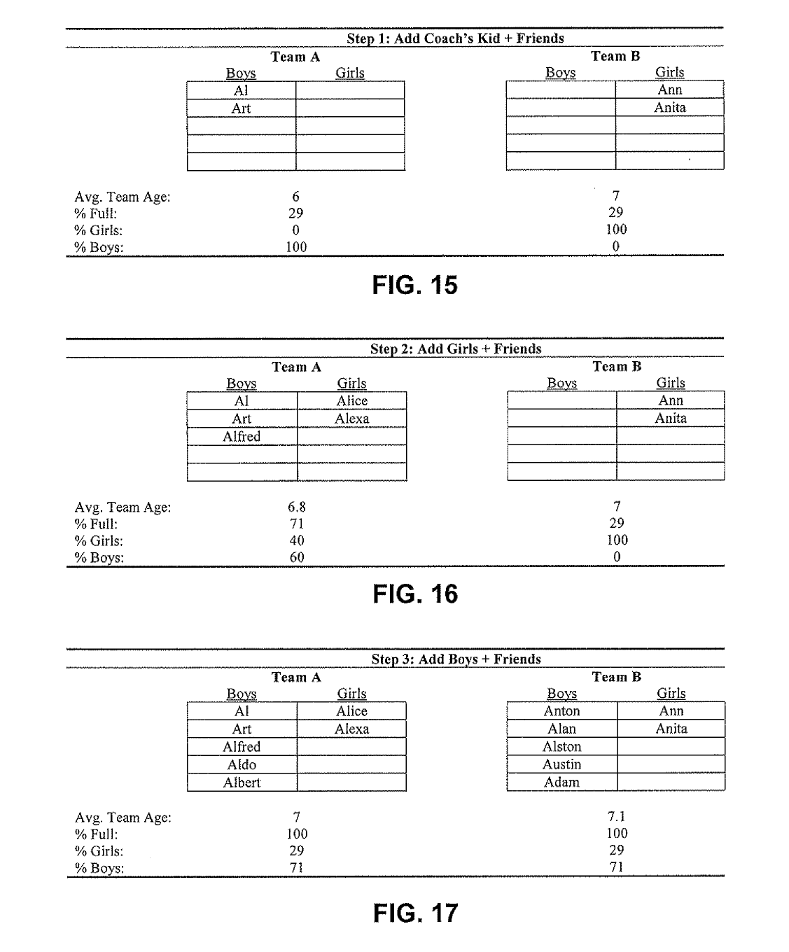

An exemplary case of a co-ed team assignment in which gender and age balancing is performed is now described with reference to FIGS. 14-17. Here again, as with age balancing, making the ratio of males to females on each team in a co-ed league substantially the same across all of the teams may help promote fairness and increase competition. In the illustrated example, there are 14 players to be assigned to two teams (Team A and Team B). More particularly, 10 of the players are male (71% of the total number of players), and 4 of the players are female (29% of the total). With the ages of the players shown in FIG. 14, the average player age for this exemplary league is 7.07 years.

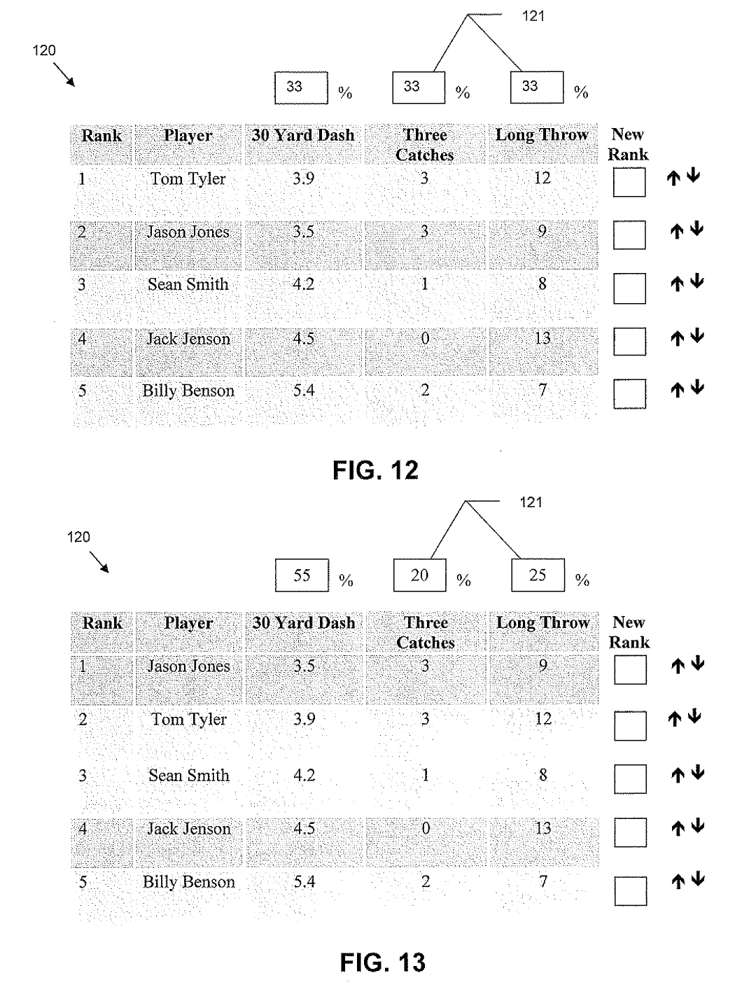

A first player assignment step is illustrated in FIG. 15. Here, the processor 40 is performing the coach-child preference assignment step, namely adding coaches' children to their respective teams. As seen in FIG. 14, Al is the son of Team A's coach, and Ann is the daughter of Team B's coach, so the processor 40 first assigns Al and Ann to Teams A and B, respectively. Then applying the recursive friend preference, Al has selected Art as his friend, and Ann has selected Anita as her friend, and these players are accordingly assigned to Teams A and B, respectively. As an aside, notice that Anita has also selected Ann as her friend, making this a double or mutual friend relationship. So, even if Art had selected Anita as his friend and Art was assigned to Team A before Ann or Anita were assigned to Team B, the processor 40 would enforce the double friend exception and not allow Anita to be assigned to Team A, as discussed further above.

At this point, the respective average team ages for Teams A and B are 6 and 7; the percentage full (assuming a maximum of sever players) is 29% for both Teams A and B; the percentage of girls is 0% for Team A and 100% for Team B; and the percentage of boys is 100% for Team A and 0% for Team B, as shown. Having completed the assignment of all coaches' children and their friends, the processor 40 next moves on to filling the teams based upon gender and age balancing. In this regard, gender balancing is performed by assigning all of the players in the unassigned player pool of one sex first, and then assigning all of the players of the other sex. This could be done in either order (i.e., girls first or boys first), but in the illustrated example the girls are assigned before boys.

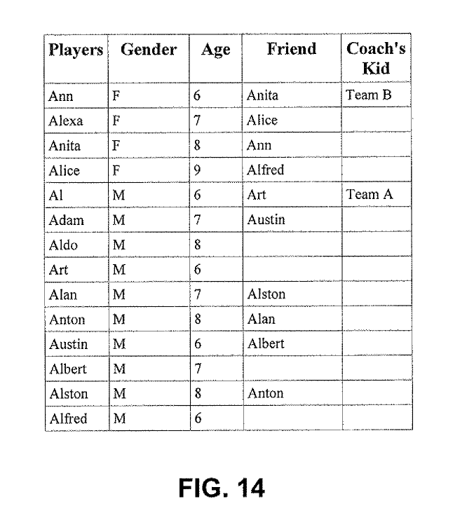

Referring to FIG. 16, at the beginning of step 2 Team A has no girls, and there are two girls left in the unassigned player pool (i.e., Alice and Alexa). As such, the processor 40 will assign one of Alice and Alexa to Team A. As described above, this may be done based upon age, selecting the team with the youngest age (here Team A, although it is the only team to which girls need to be added in this simple example), and adding the oldest girl not yet assigned to a team (here Alice), or vice-versa. Again, age balancing need not be used in all embodiments, and the next female to be assigned could be selected in another fashion, such as by date of signup, alphabetically, order stored in the database, etc. Here, Alice is the first female player assigned by the processor 40 to Team A due to age, and her friend selection preference of Alfred causes him to be added to Team A as well. Moreover, Alexa's friend preference of Alice would also cause her to be added to Team A at this point, even though she would otherwise have been added to Team A anyway because she is the last remaining girl to be assigned, and adding her to Team A balances the female percentage between Teams A and B (i.e., 29%). Moreover, the average team ages at this point are 6.8 for Team A and 7 for Team B; the total full percentage is 71% for Team A and still 29% for Team B; the percentage of girls is 40% for Team A and 100% for Team B; and the percentage of boys is 60% for Team A and 0% for Team B.

With all of the girls assigned to teams and balanced between the teams (i.e., two girls are on each team), the processor 40 may proceed to complete the team assignments by filling in all of the remaining boys who have not yet been assigned to teams. Since Team A still has the lowest average team age at this point, the first boy to be assigned will go to Team A, and it will be the oldest boy remaining in the unassigned player pool, namely Aldo. Note that while age is only shown by year in FIG. 14 for clarity of illustration, and there are other eight year old boys remaining in the player pool, for purposes of this example it should be assumed that Aldo is the oldest of the remaining eight year olds (i.e., he has the earliest birthday). As such, Aldo is assigned to Team A.

Since Aldo has not selected a friend, and since the average age of Team A has risen above that of Team B with Aldo's addition, Team B now gets the oldest remaining boy player, which is Anton. Applying the recursive friend preference, Anton has selected Alan as his friend, so Alan is added to Team B. Further, Alan has selected Alston as his friend, so Alston too is added to Team B. Note that Alston has selected Anton as his friend, so he too is added to Team B at this point.

With these latest assignments, the lowest average age again shifts back to Team A, so it is assigned the oldest remaining player, namely Albert. This completely fills Team A, so the processor 40 returns to Team B and adds the only remaining player thereto, namely Adam. So, with all of the player spots filled using a combination of preference and age/gender balancing, the final results of the team demographics are as follows: average team age of 7 for Team A and 7.1 for Team B; both teams are 100% full; an average female percentage of 29% for Team A and Team B; and an average male percentage of 71% for Team A and Team B. Of course, the team percentages will not always work out to be the same as the overall percentage of males and females in a league, particularly given a large amount of available preference options and usage, as discussed above. However, this example demonstrates how the processor 40 may advantageously perform assignment operations to drive the male/female and age percentages toward desired thresholds to help promote team fairness and enhance competition, as will be appreciated by those skilled in the art.

In accordance with one variant of age assignment, it may be desirable to assign the oldest player not to the youngest average age team, but instead to a next youngest team. For example, this might be desirable if there is a chain of several players who have designated each other as friends, and the administrator deems friend preferences to be of more importance in team assignment than age balancing. So, if the youngest age team only had one spot left, yet the oldest remaining player was in a chain of two or more friends that would otherwise be assigned to a same team using the recursive friend preference, the processor 40 may jump to the next youngest age team to see if the requisite number of open slots exist on the team and, if so, assign the players here instead.

It should be noted that the above-described assignment steps and exception steps could be implemented in different orders in different embodiments, if desired. Moreover, it should also be noted that variations of the above-described player assignment steps and exceptions may be employed. For example, the friend preference may be implemented as a separate step, rather than being performed recursively in conjunction with each of the steps illustrated at Blocks 62-68. In other words, the processor 40 may wait until after the coach-child, preferred coach, practice day preference, etc., are run (or sometimes before one or more of these steps), and then assign the players remaining in the unassigned player pool based upon designated friend preferences. Another example is that the “no coach” preference may be proactively accommodated, rather than in a reactive fashion. For example, the processor 40 may determine which players have a “no coach” preference, and then assign each of those players to a different team from the one the particular coach is associated with, rather than waiting until the player is otherwise slated for assignment to a team and reactively overriding the assignment based upon a coach conflict. In some embodiments, the administrator may be able to select or customize the order in which the processor 40 performs the preferences (e.g., as an advance user setting). Conclusion of the team assignment operations is illustratively shown at Block 69 (FIG. 3).

In addition, preference assignment options are not solely for use in leagues where there is no draft. That is, some of the above-described preferences/considerations and/or exceptions may also be used in an automatic draft in some circumstances. One notable consideration or preference is that, even where a draft takes place, a coach's child(ren) will be assigned to the coach's team (i.e., a coach's child cannot be drafted by a different coach on another team), if so designated by the administrator. In such event, to promote fairness, the processor 40 may “draft” the child for his parent's team during the round in which the child's skill results would otherwise have placed him or her based upon the default ranking. For example, if there are to be ten teams in a league and a coach's child ranked among the top ten players based upon his or her skills assessment results, then that player would be drafted by the processor 40 for his or her parent's team in the first round of the draft. That is, the parent/coach would not get to make a different player pick in that round, rather the child's selection to the team would automatically be enforced by the processor 40.

The processor 40 may advantageously provide numerous helpful features to administrators for evaluating and/or changing team assignment results. For example, the if the administrator chooses, the team assignments could be run in steps, such as the steps 1, 2, and 3 shown in FIGS. 15-16. As such, at the end of each step the administrator would see exactly how the assignments are being made, and may make changes (or change a preference option and re-run the step) if desired. For example, the player names may be capable of dragging and dropping (e.g., using an input device such as a mouse coupled to the administrator's computer) to a different team. Along with this, warning indicators could be provided letting the administrator known when such a move would violate a player's designated preference or other consideration. In this regard, visual lines or “ligaments” between the name of the player being moved and another name (e.g., friend's name, coach's name, etc.), may be provided to visually indicate to the administrator which preferences or associations he will be breaking by such a move. Of course, similar options could be provided after all the teams are filled, rather than between steps, if the administrator chooses not to observe the team fills step-by-step.

Another helpful tool that may be generated for the administrator (or coaches or parents to varying degrees) is reports showing which preferences were satisfied and/or which ones could not be satisfied, along with the reasons why or why not. Furthermore, pre-assignment reports or statistics may be generated to provide the administrator with information that would be helpful to know before initiating a draft or team assignment, such as which preferences or conditions will not be satisfied so he can make adjustments accordingly, if desired. For example, if the maximum number of players has been reached and there is a wait list, the administrator may want to change the maximum player per team or maximum team limit to accommodate those players on the wait list. Similarly, such a pre-assignment report or review may be used to inform players (e.g., via email or a Web page accessed via the server 31) which of their preferences will not be satisfied so they have a chance to sign on and readjust their preferences.

With regard to wait lists, one difficulty with registering a player for a popular league that fills up quickly is that while a player is in the middle of a series of forms, the league may actually be filled up by other players completing their registration forms first. Accordingly, the processor 40 may advantageously check the database 41 whenever the processor opens a new or subsequent form to see if the league is full at that point in time. If so, the processor 40 may advantageously count the number of players on the wait list, and inform the applicant of the number of players ahead of him or her on the wait list, and give the user the option to cancel registration and look for a new league or continue and be placed on the wait list.

Another operation that may be performed by the processor 40 is game scheduling for the leagues, at Block 54. Generally speaking, the processor 40 uses the information provided by the administrator and stored in the database 41 regarding the designated times and fields/courts that have been scheduled for the games. Various considerations are taken into account when making the game schedules. First, teams should be matched up against every other team in the league, where possible, and if some teams are to be played twice a preference toward playing teams in a same division twice may be implemented. That is, division teams are the first to get rematches, then teams from other divisions.

Beyond these basic game scheduling constructs, further game scheduling features may advantageously be implemented by the processor 40 in some applications, either as a default procedure performed by the processor or as customizable game scheduling options available to the league administrator. One such feature is the rotation of game times for teams from week to week to promote fairness. That is, it is generally desirable to make sure that no team gets the early or late game more often than not, or frequently has to play games during the hottest times of the day. In this regard, game scheduling rotation could be performed using “round robin” scheduling with game time assignments, so some teams progressively get scheduled from earlier to later games, and others from later to earlier games. The processor 40 may also rotate field assignments if multiple fields are used in a local league. For traveling leagues, the processor 40 may attempt to balance the number of home and away games a team plays.

Another game scheduling approach is that the server 31 may be connected to an Internet-based weather service, and accordingly track what the game conditions are at the various times that teams play each week. New game assignments could be made (or old ones adjusted) to make sure the teams all “average” a certain playing temperature (i.e., if a team has played during a particularly hot time, then the team could be scheduled for the following week at a cooler forecasted game time). Similarly, this could also be done with precipitation, for example, scheduling a team that has been rained out one week during the time slot predicted to have the least change of rain the following week so the team is less likely to have two games cancelled, etc., due to rain or other inclement weather.

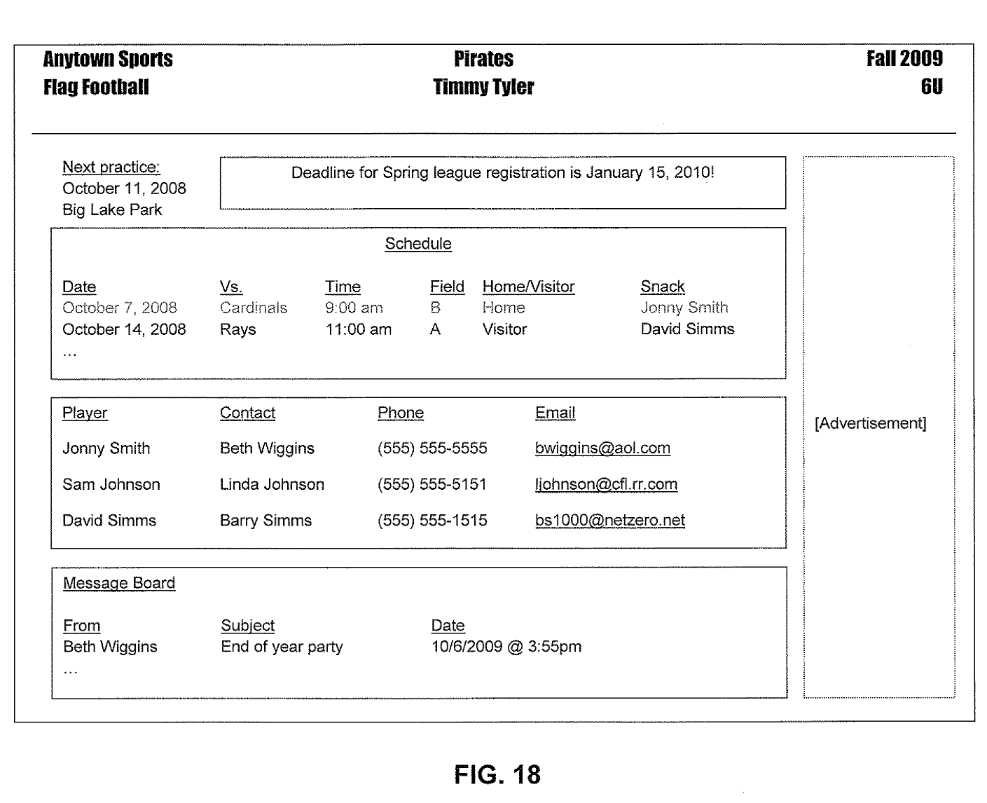

The processor 40 may further cooperate with the database 41 to generate user and/or team information pages for players, coaches, and administrators to access their respective account or team information, at Block 55. An exemplary team information page 180 generated for a player named Timmy Tyler is shown in FIG. 18 for a Fall 2009 flag football league with the league name “6U” (i.e., a 6+ year old league), sponsored by the “Anytown Sports” organization. The player's team name is the Tigers. The team page 180 illustratively includes a reminder for the next practice, a message from the administrator about the next season's registration deadline, as well as a game schedule area, parent contact area, and a message board. The message board is where players, parents, coaches, or league administrators may go to send messages to other players, parents, or coaches, as will be appreciated by those skilled in the art, at Block 56, thus concluding the method illustrated in FIG. 2 (Block 57). Again, the messages may be delivered by email and/or text (e.g., SMS) messaging, depending upon the options selected by the recipient users when signing up for the system and the importance of the message, as discussed further above.

Many modifications and other embodiments of the invention will come to the mind of one skilled in the art having the benefit of the teachings presented herein. Therefore, it is understood that the invention is not to be limited to the specific exemplary embodiments disclosed herein, and that various modifications and embodiments are intended to be included within the scope of the appended claims.

That which is claimed is:

1. A participant assignment system for assigning a plurality of participants to a plurality of different teams and comprising:
a participant database configured to store participant data for each participant comprising participant age and at least one participant preference; and
a processor coupled to said participant database and configured to
(a) assign a given participant to a given team based upon the age of the given participant and overall team ages for the plurality of different teams,
(b) recursively assign other participants to the given team based upon participant preferences, and
(c) repeat (a) and (b) until each of the plurality of participants is assigned to a respective team.

2. The participant assignment system of claim 1 wherein the participant data further comprises participant gender; and wherein (a) further comprises assigning the given participant to the given team also based upon the gender of the given participant and team gender ratios.

3. The participant assignment system of claim 1 wherein the at least one participant preference comprises a preference to be assigned with another participant.

4. The participant assignment system of claim 1 wherein each of the plurality of different teams has a coach assigned thereto; and wherein the at least one participant preference comprises a preference to be assigned with a given team coach.

5. The participant assignment system of claim 4 wherein said processor is further configured to limit a number of participant assignments based upon participant preferences for a given team coach.

6. The participant assignment system of claim 1 wherein the at least one participant preference comprises a team practice day preference.

7. The participant assignment system of claim 1 wherein the participant data further comprises at least one participant exception; and wherein (b) further comprises recursively assigning other participants to the given team based upon participant preferences and participant exceptions.

8. The participant assignment system of claim 7 wherein the at least one participant exception comprises a team coach exception.

9. The participant assignment system of claim 8 wherein said processor is further configured to limit a number of participant exceptions for a given team coach.

10. The participant assignment system of claim 7 wherein the at least one participant exception comprises a team practice day exception.

11. A participant assignment system for assigning a plurality of participants to a plurality of different teams and comprising:
a participant database configured to store participant data for each participant comprising participant gender and at least one participant preference; and
a processor coupled to said participant database and configured to
(a) assign a given participant to a given team based upon the gender of the given participant and team gender ratios,
(b) recursively assign other participants to the given team based upon participant preferences, and
(c) repeat (a) and (b) until each of the plurality of participants is assigned to a respective team.

12. The participant assignment system of claim 11 wherein the at least one participant preference comprises a preference to be assigned with another participant.

13. The participant assignment system of claim 11 wherein each of the plurality of different teams has a coach assigned thereto; and wherein the at least one participant preference comprises a preference to be assigned with a given team coach.

14. The participant assignment system of claim 11 wherein the participant data further comprises at least one participant exception; and wherein (b) further comprises recursively assigning other participants to the given team based upon participant preferences and participant exceptions.

15. A participant assignment method for assigning a plurality of participants to a plurality of different teams and comprising:
(a) storing participant data for each participant in a participant database, the participant data comprising participant age and at least one participant preference;
(b) assigning a given participant to a given team based upon the age of the given participant and overall team ages for the plurality of different teams;
(c) recursively assigning other participants to the given team based upon participant preferences, and
(d) repeating (b) and (c) until each of the plurality of participants is assigned to a respective team.

16. The method of claim 15 wherein the participant data further comprises participant gender; and wherein (b) further comprises assigning the given participant to the given team also based upon the gender of the given participant and team gender ratios.

17. The method of claim 16 wherein the at least one participant preference comprises a preference to be assigned with another participant.

18. The method of claim 16 wherein each of the plurality of different teams has a coach assigned thereto; and wherein the at least one participant preference comprises a preference to be assigned with a given team coach.

19. The method of claim 16 wherein the at least one participant preference comprises a team practice day preference.

20. The method of claim 16 wherein the participant data further comprises at least one participant exception; and wherein (c) further comprises recursively assigning other participants to the given team based upon participant preferences and participant exceptions.
